(19) United States
(12) Patent Application Publication
(10) Pub. No.: US 2009/0005969 A1
(43) Pub. Date: Jan. 1, 2009

(54) NAVIGATION APPARATUS AND METHOD OF CONTROLLING NAVIGATION APPARATUS

(75) Inventor: Tadashi TAMURA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/126,662

(22) Filed: May 23, 2008

(30) Foreign Application Priority Data
Jun. 26, 2007 (JP) 2007-167654

(51) Int. Cl. G01C 21/00

(52) U.S. Cl. 701/202; 701/201

(57) ABSTRACT

A navigation apparatus includes a map data controller adapted to read map information from a map data supply apparatus disposed outside the navigation apparatus and store the map information in the storage unit, and a control unit adapted to control a position measurement unit, a storage unit, and the map data controller. The control unit obtains a current position via the position measurement unit, and detects a unique place reachable from the current position on the basis of information associated with a transport system and the unique place supplied from the map data supply apparatus. The control unit determines map information of an area necessary in providing route guidance to the unique place from the current position, and controls the map data controller so as to read the map information of the area from the map data supply apparatus and store the map information in the storage unit.

### CROSS REFERENCES TO RELATED APPLICATIONS

The present invention contains subject matter related to Japanese Patent Application JP 2007-167654 filed in the Japanese Patent Office on Jun. 26, 2007, the entire contents of which are incorporated herein by reference.

### BACKGROUND OF THE INVENTION

1. Field of the Invention

The present invention relates to a navigation apparatus and a method of controlling a navigation apparatus.

2. Description of the Related Art

A navigation apparatus is widely used, which detects a current position of a moving vehicle and provides route guidance to a destination, by using a position detection technique based on a combination of a GPS (Global Positioning System) and map data. In recent years, a reduction in the physical size of the navigation apparatus has been achieved. In fact, a portable type of navigation apparatus has been proposed which can be carried and used by a user who moves on foot. However, it is difficult for such a portable type of navigation apparatus to have as much detailed map information stored therein as map information supplied by a DVD (Digital Versatile Disc) disk in a car navigation system. That is, state-of-the-art storage devices available, as of the time of application of the present invention, for use in portable navigation apparatus do not have as large a storage capacity as the storage capacity of DVD disks, and thus it is difficult to carry a sufficiently large amount of information. A modified portable navigation apparatus has been proposed which operates as follows. In this proposed technique, not the whole navigation apparatus is brought out from a vehicle, but only a portable part of the navigation apparatus is brought out from the vehicle, and a navigation functions are provided for a rather small area by the portable part (for example, see Patent Documents 1 to 4, listed below).

Patent Document 1: Japanese Unexamined Patent Application Publication No. 6-137877

Patent Document 2: Japanese Unexamined Patent Application Publication No. 10-103999

Patent Document 3: Japanese Unexamined Patent Application Publication No. 9-81885

Patent Document 4: Japanese Unexamined Patent Application Publication No. 7-229752

The techniques disclosed in these Patent Documents 1 to 4 are described below.

In the technique disclosed in Patent Document 1, a navigation apparatus includes a first storage unit serving as a fixed part which is adapted to store map information and which is removable from a portable part and is fixed to a vehicle. The navigation apparatus also includes the portable part including a position detection unit adapted to detect the position of the moving portable part, a second storage unit adapted to read map information of an area surrounding of the current position detected by the position detection unit and store the map information therein, a display unit adapted to display the map information, and a display control unit adapted to display the current position of the portable unit detected by the position detection unit together with the map information on the display unit. The fixed part serving as the first storage unit and the portable part including the second storage unit are configured to be separable from each other. In a state in which the first storage unit is separated, the portable part provides navigation functions using map information stored in the second storage unit implemented by a RAM (Random Access Memory) or the like which is small in size and in storage capacity.

In the technique disclosed in Patent Document 2, a navigation apparatus is implemented by a combination of a main navigation apparatus disposed firmly in a vehicle and a sub navigation apparatus removably mounted in the vehicle. When the sub navigation apparatus is brought out of the vehicle, map information of an area necessary in providing route guidance of a walking route is transferred from an in-vehicle database disposed in the main navigation apparatus into a RAM of the sub navigation apparatus serving as a portable part thereby making it possible to provide navigation functions using only the portable part.

In the technique disclosed in Patent Document 3, navigation information of an automatically selected area surrounding a current position detected using a GPS apparatus or navigation information of this automatically selected area and also an additional manually-selected area is searched for from navigation information stored in a high-capacity storage unit (database) of a fixed part of a navigation apparatus, and navigation information found in the search process is transferred via a communication unit to a portable information processing terminal serving as a portable navigation apparatus. The transferred navigation information is stored in a data memory disposed in the portable information processing terminal, and the navigation information stored in the data memory is displayed on a display unit in accordance with an operation performed on an operation unit.

In the technique disclosed in Patent Document 4, navigation information stored in a high-capacity storage unit (database) of a fixed part of a navigation apparatus is stored in an IC (Integrated Circuit) card, and a portable operates as a navigation apparatus using the information stored in the IC card.

### SUMMARY OF THE INVENTION

In the techniques disclosed in Patent Documents 1, 2, and 4, when the portable part is disconnected from the fixed part, a map of an area including a position of the navigation apparatus at this point of time and/or a map of an area including a specified destination point are extracted. However, to realize the portable part in a small form, it is necessary to reduce the storage device (RAM, IC card, etc.) disposed in the portable part. As a result, the storage device of the portable part has a small storage capacity which sometimes makes it difficult to store as much information as needed in navigation. In the technique disclosed in Patent Document 3, supplementary information is acquired via a communication device. However, in this technique, in a circumstance where a radio wave condition is bad, such as in a building or in a valley, it is difficult to transfer map information. The difficulty in transferring map information can cause a problem to occur in the navigation operation, which can cause a user of the navigation apparatus to get lost.

In view of the above, it is desirable to provide a portable navigation apparatus capable of providing navigation functions over an extended large area even in a case where a storage device has a small storage capacity, and it is also desirable to provide a method of controlling such a navigation apparatus.

In view of the above, according to an embodiment, the present invention provides a navigation apparatus adapted to provide route guidance to a destination point, comprising a position measurement unit adapted to measure a position, a storage unit adapted to store map information, an image display unit adapted to display the map information in the form of a visual image, a map data controller adapted to read the map information from a map data supply apparatus disposed outside the navigation apparatus and store the map information in the storage unit, and a control unit adapted to control the position measurement unit, the storage unit, and the map data controller, the control unit being adapted to control the position measurement unit to obtain a current position, detect one or more unique places reachable from the current position on the basis of information supplied from the map data supply apparatus in terms of a transport system and in terms of the unique places, determine map information of an area for use in providing route guidance to the unique places from the current position, and control the map data controller to read the determined map information of the area from the map data supply apparatus and store the map information in the storage unit.

In this navigation apparatus, the control unit controls the position measurement unit, the storage unit, and the map data controller. The control unit detects one or more unique places reachable from the current position, on the basis of information indicating the measured current position, the information associated with the transportation system, and the information associated with the unique places. Map information of an area necessary in getting to the unique places is determined, and only the necessary map information is selectively stored in the storage unit. Thus, it is possible to properly provide navigation functions, using map information of the limited area.

According to an embodiment of the present invention, there is provided a method of controlling a navigation apparatus adapted to read map information from a map data supply apparatus disposed outside the navigation apparatus, store the map information in a storage unit disposed in the navigation apparatus, and provide route guidance associated with a route to a destination point in accordance with the map information, comprising the steps of measuring a current position, detecting one or more unique places reachable from the current position, on the basis of information associated with a transportation system, and reading map information of an area for use in providing route guidance from the current position to the one or more unique places from the map data supply apparatus and storing the map information in the storage unit.

In the method of controlling the navigation apparatus, the current position is measured, one or more unique places reachable from the current position are detected on the basis of information associated with a transportation system, and map information of an area for use in providing route guidance from the current position to the one or more unique places is read from the map data supply apparatus and stored in the storage unit. Thus, it is possible to properly provide navigation functions, using map information of the limited area.

As described above, the present invention provides the small-sized portable navigation apparatus capable of providing route guidance over a large area. The present invention also provides the method of controlling such a navigation apparatus.

### BRIEF DESCRIPTION OF THE DRAWINGS

FIG. 1 is a diagram schematically illustrating a navigation system;

FIG. 2 is a block diagram of a navigation system;

FIG. 3 is a flow chart illustrating a process of disconnecting a navigation apparatus from a map data supply apparatus;

FIG. 4 is a flow chart illustrating a process of determining content of information to be downloaded;

FIG. 5 illustrates examples of areas whose map information is downloaded into a ROM or a RAM according to an embodiment of the present invention;

FIG. 6 is a flow chart illustrating a process performed by a control unit according to an embodiment of the present invention; and

FIG. 7 illustrates examples of areas whose map information is downloaded into a ROM or a RAM according to an embodiment of the present invention.

### DESCRIPTION OF THE PREFERRED EMBODIMENTS

### Overview of Embodiments

Overviews are first described as to an embodiment of a navigation apparatus and an embodiment of a method of controlling a navigation apparatus, before detailed descriptions thereof are provided. The navigation apparatus includes a position measurement unit adapted to measure a current position. The navigation apparatus also includes a RAM serving as a storage unit used to store detailed map information (map data, picture information, etc.). The navigation apparatus has a capability of combining information indicating the current position detected by the position measurement unit and the detailed map information stored in the RAM, and displaying resultant information on an image display unit such that the current position is visually recognizable. The navigation apparatus also includes a control unit that controls an operation of the navigation apparatus. The control unit controls reading of detailed map information from a map data supply apparatus into the RAM, not in such a manner that detailed map information of an area with a predetermined area size is simply read, but in such a manner that a determination as to which area should be read is made on the basis of associated additional information, and detailed map information of the determined area is read from the map data supply apparatus into the RAM. In the present description, the term “associated additional information” is used to generically refer to information, other than map information, useful for a user of the navigation apparatus. More specifically, specific examples of associated additional information are information indicating locations of major landmarks near to the current position, locations of getting-on/off points of public transportation systems such as train stations or bus stops, locations of places which can be attractive for many people (hereinafter, landmarks, attractive places, and the like will be generically referred to as unique places), information indicating public transportation routes to unique places, information indicating timetables of public transportation systems, and information indicating typical trip times needed to take sightseeing trips around the respective unique places. The navigation apparatus is adapted to be usable in two modes: a mode in which the navigation apparatus is used in a state in which the navigation apparatus is connected to the map data supply apparatus; and a mode in which the navigation apparatus is used solely in a state in which the navigation apparatus is not connected to the map data supply apparatus. The navigation apparatus is configured in a small form such that the user can easily carry the navigation apparatus. The map data supply apparatus is a high-capacity storage device in which map information of an entire country such as Japan is stored in a hierarchical manner in terms of precision, and the map data supply apparatus has a rather large size. In a case where the navigation apparatus is used separately from the data supply apparatus, when the navigation apparatus is disconnected from the data supply apparatus, the control unit extracts necessary detailed map information from the data supply apparatus and stores the extracted detailed map information in a RAM. Note that, in this map information extraction/storage process, as described above, the detailed map information is extracted not so as to include an area with the predetermined area size but so as to include an area selected on the basis of associated additional information. The control unit checks whether the data size of the detailed map information of the selected area is equal to or smaller than a maximums allowable data size which can be stored in the RAM. If it is determined that the data size of the detailed map information of the selected area is equal to or smaller than the maximum allowable data size which can be stored in the RAM, the control unit downloads the detailed map information of the selected area into the RAM. Note that the detailed map information downloaded via the process described above is not of an area within a range from the current position to a predetermined fixed distance, but of the area automatically determined by the control unit as being most necessary for a user of the navigation apparatus (hereinafter, referred to simply as a user). Thus, although the storage capacity of the RAM is small, it becomes possible to provide navigation functions over a much greater range by using the map information stored in the RAM than can be provided by other techniques. That is, the user is allowed to move over a much greater range using the navigation apparatus.

Note that the area of the detailed map information read from the map data supply apparatus into the RAM is automatically determined by the control unit by executing a procedure in accordance with software which controls the control unit. More specifically, for example, the area of the detailed map information read into the RAM is determined such that the detailed map information includes detailed map information of an area reachable by the user on foot or by bicycle and also include detailed map information for use in providing route guidance to a unique place such as a landmark reachable using a public transportation system such as a train, a bus, and/or the like, and also detailed map information along respective routes from the current position to train stations or bus stops at which to get on a train or a bus and also along respective routes to final destinations from train stations or bus stops at which to get off a train or a bus, thereby to make it possible to provide route guidance from the current position to the respective landmarks. That is, the area of detailed map information to be stored in the RAM is not simply determined so as to have a fixed area size (for example, a circular area with a particular radius including the current position and the destination point), but only detailed map information of one or more areas necessary in providing route guidance is stored in the RAM so that it is possible to surely guide the user to the destination point by efficiently using the detailed map information with a small data size stored in the RAM. The unique places are not limited to landmarks but may be of various kinds, such as spots receiving attention, prefectural capitals, etc., differentiable from other places. A unique place may be selected by a user of the navigation apparatus. A first destination point and a second destination point or three or more destination points may be specified, and route guidance may be provided sequentially for the first destination point, the second destination point, the third destination point, and so on. The second destination point may be set at the original starting point so that route guidance is provided for a route from the original starting point to the first destination point and then for a route from the first destination point to the original starting point set as the second destination point.

Contents of detailed map information read from the map data supply apparatus into the RAM are not limited to information associated with roads accessible by automobiles, but the detailed map information may additionally include information associated with walkable narrow paths detected from an aerial photography map. An optimum hiking route, which allows a user to reach a destination point (a first destination point) in a shortest time, may be selected by the controller, and the detailed map information may be extracted so as to include the selected hiking route and stored in the RAM. Information associated with a route of a public transformation system and a timetable thereof may be stored, as associated additional information, in the RAM, and, in accordance with the current position, the current time, and the timetables, the control unit may display getting-on stations/stops of available public transportation systems and timetables on a display screen thereby to inform the user of a route to another new destination point (a second destination point) and an estimated arrival time at the new destination point (note that the new destination point may be the start point, and the route may be a route back to the starting point).

The embodiments of the present invention are described in further detail below with reference to the accompanying drawings.

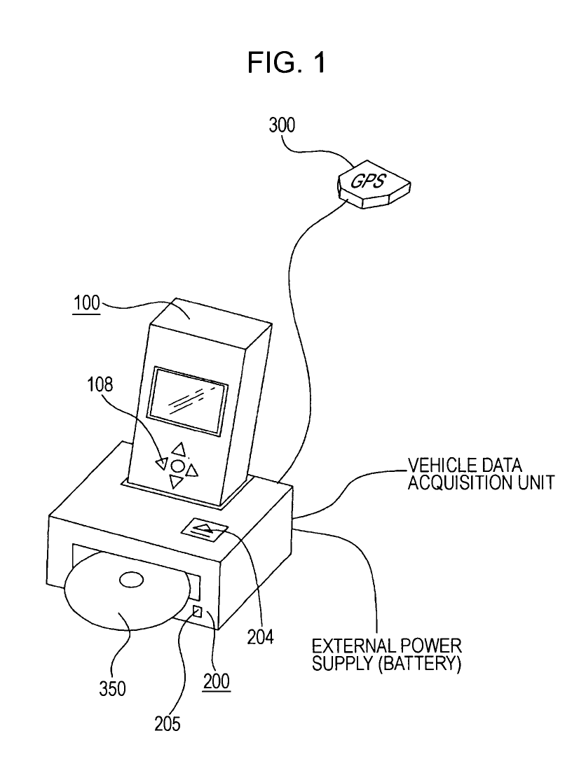

FIG. 1 is a diagram illustrating an external appearance of a navigation system according to an embodiment of the present invention. In the present embodiment, the navigation system 10 includes a navigation apparatus 100, a map data supply unit 200, and an external antenna 300. The map data supply unit 200 is adapted to receive data associated with the vehicle from a vehicle data acquisition unit, such as data indicating a vehicle running speed, data indicating whether a parking brake is set, a signal from the external antenna 300, and electric power from an external power supply (battery). The map data supply apparatus 200 includes an eject button 204 and a remote control receiver 205. Although not shown in any figure, the navigation system 10 includes a remote control transmitter which is operated by the user of the navigation system 10 to transmit a signal from the remote control transmitted to the remote control receiver 205 thereby to control the operation of the navigation system 10. The map data supply apparatus 200 is configured such that a DVD (Digital Versatile Disc) 350 can be inserted in the map data supply apparatus 200.

The navigation apparatus 100 is adapted to be connectable to the map data supply apparatus 200 via an insertion slot formed in the map data supply apparatus 200 so that the navigation apparatus 100 can operate in cooperation with the map data supply apparatus 200 so as to provide functions similar to those provided by a usual car navigation system when the vehicle is running. If the eject button 204 is operated, the navigation apparatus 100 is brought into a state in which the navigation apparatus 100 can be removed from the insertion slot. After the navigation apparatus 100 is removed from the insertion slot, the navigation apparatus 100 can singly operate to provide navigation functions. The navigation apparatus 100 includes an operation input unit 108 adapted to be operated by a user, in a similar manner to the remote control transmitter, to control the operation of the navigation system 10.

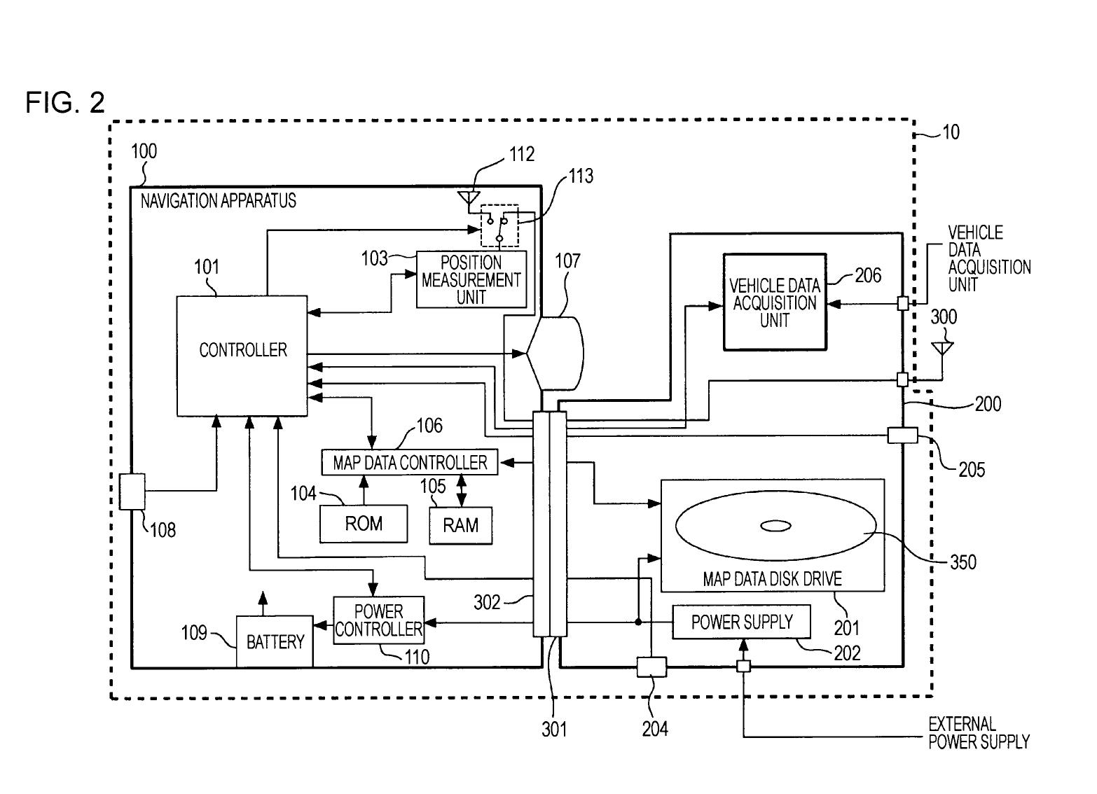

FIG. 2 is a block diagram of the navigation system 10 according to the present embodiment. In the navigation system 10 according to the present embodiment, as shown in the block diagram of FIG. 2, the navigation apparatus 100 and the map data supply apparatus 200 are connected to each other via a connector 302 and a connector 301 in such a manner that they are disconnectable. The navigation apparatus 100 and the map data supply apparatus 200 transmit various kinds of information between them via the connector 302 and the connector 301. The information transmitted between them includes a signal received by the external antenna 300 and supplied to a position measurement unit 103, data indicating a state of the vehicle transmitted between the vehicle data acquisition unit and the control unit 101, data associated with an operation transmitted from the remote control receiver 205 to the control unit 101, map data transmitted between a map data disk drive 201 of the map data supply apparatus 200 and the control unit 101, data for controlling the map data disk drive 201 transmitted between the map data disk drive 201 of the map data supply apparatus 200 and the control unit 101, and an eject signal transmitted from the eject button 204 to the control unit 101. Furthermore, via the connector 302 and the connector 301, electric power is supplied from a power supply 202 to a power controller 110.

### Overview of Navigation Apparatus

The navigation apparatus 100 is configured so as to include the control unit 101, the operation input unit 108 used by a user (who operates the navigation apparatus 100) to input an operation control signal to the control unit 101, the position measurement unit 103 adapted to measure the current position under the control of the control unit 101 and supply position information to the control unit 101, an image display unit 107 adapted to display navigation information in a visible form under the control of the control unit 101, a map data controller 106 adapted to supply information associated with map data to the control unit 101 under the control of the control unit 101, a ROM (Read Only Memory 104 and a RAM (Random Access Memory) 105 which is controlled by the map data controller 106, an antenna selection switch 113 adapted to switch the connection between the position measurement unit 103 and an antenna such that either an internal antenna 112 or the external antenna 300 is selected and connected to the position measurement unit 103, a battery 109 adapted to supply electric power to the above-described respective parts of the navigation apparatus 100, and a power controller 110 adapted to manage and control the charging state of the battery 109 and supply electric power to the navigation apparatus 100.

On the other hand, the map data supply apparatus 200 has a storage medium in which map data is stored, and the map data supply apparatus 200 supplies the map data to the navigation apparatus 100 under the control of the navigation apparatus 100. As for the storage medium, many types of storage media, such as a hard disk, an optical disk medium, a magnetic tape medium, etc., may be used. In the present embodiment, an optical disk medium is used as the storage medium. The map data supply apparatus 200 includes the map data disk drive 201 adapted to read map information stored in the map data disk, and also includes the power supply 202. The map data disk drive 201 is, for example, a DVD reading apparatus adapted to read data from a DVD disk. The DVD disk has a storage capacity of 4.7 Gbytes. The map data disk drive 201 may be configured such that one DVD disk 350 is mounted on the map data disk drive 201 and data is read from the mounded DVD disk 350. Alternatively, the map data disk drive 201 may be configured in the form of a so-called changer type in which one DVD disk is automatically selected from a plurality of DVD disks and mounted on the map data disk drive 201 thereby achieving an effective increase in storage capacity. The power supply 202 is a part adapted to supply electric power consumed in the map data supply apparatus 200 and also in the navigation apparatus 100. When the vehicle is running, the power supply 202 receives electric power from the external power supply (battery) disposed in the vehicle, and the power supply 202 regulates the voltage of the received electric power by increasing or reducing the voltage thereby obtaining a regulated voltage suitable for driving the navigation system 10. That is, the power supply 202 is configured so as to operate as a constant-voltage power supply. The vehicle data acquisition unit 206 is a part adapted to acquire information associated with running conditions of the vehicle such as a vehicle running speed from signals supplied from vehicle operation control parts (not shown) such as an accelerator pedal, a brake pedal, and a parking brake lever.

### Overview of Map Data Supply Apparatus

Map information stored on the DVD disk 350 mounted on the map data disk drive 201 of the map data supply apparatus 200 includes map drawing data, intersection data, road data, picture information based on aerial photographic information or satellite photographic information, and area-specific information indicating hotel names, sightseeing information, and other useful information specific to each area. The information stored on the DVD disk 350 is used as source data from which to form an image displayed on the image display unit 107. The map drawing data is data according to which to display a map, and the map drawing data is expressed in a hierarchical manner according to map scales. More specifically, the map drawing data is expressed in the form of a hierarchical database, for example, in such a manner that a map of Japan is expressed in a highest level, a map of Kanto district is expressed in a next highest level, and a map of Tokyo and a map of Minato-ku are expressed in following lower levels, and so on. Data in the lowest hierarchical level expresses a map in a finest scale, and not only major roads but also narrow alleys, store names, and other detailed information are described in this level. Hereinafter, information expressed in this lowest hierarchical level will be referred to simply as detailed map information. The intersection data is data indicating names of intersections, coordinates of locations thereof, and roads forming intersections. The road data is data which is necessary in providing route guidance and which includes data indicating the width and the length of each road and indicating traffic information such as prohibition of entrance associated with each road. The aerial photographic information is information obtained from aerial photography and representing shapes of buildings in city/town areas and shapes of mountains in mountain areas. The satellite photographic information is information obtained from pictures taken by satellites over areas greater than those of aerial photography. The area-specific information indicating hotel names, sightseeing information, and other useful information specific to each area is expressed by map symbols to indicating locations of hotels, sightseeing spots, etc., expressed in coordinates. In mountain areas, there are no alleys and no stores, and thus the detailed map information of mountain areas is directly given by aerial photography or a topographic maps produced based on aerial photography. The detailed map information of mountain areas may include additional information indicating walkable narrow mountain paths.

In the operation mode in which the navigation apparatus 100 is not carried by a user but the navigation apparatus 100 is used in the state in which the navigation apparatus 100 is connected to the map data supply apparatus 200, as described above, the navigation apparatus 100 and the map data supply apparatus 200 are electrically connected to each other via the connector 302 and the connector 301, and the map data disk drive 201 is controlled by the map data controller 106 so that information necessary by the map data controller 106 is read from the DVD. Electric power is supplied from the power supply 202 to the power controller 110 via the connector 302 and the connector 301 so that the battery 109 is maintained in a charged state. In this operation mode, the navigation apparatus 100 and the map data supply apparatus 200 cooperates so as to provide the navigation function.

### Brief Description of Each Part of Navigation Apparatus

The navigation apparatus 100 is further explained for each of parts thereof to provide information necessary to understand the present embodiment. The control unit 101 is a key unit responsible for controlling the navigation system 10, and includes a CPU (Central Processing Unit), a RAM connected to the CPU via a bus line for use by the CPU, a ROM for use by the CPU, and an image display driver connected to an input/output port of the CPU for driving the image display unit 107 (these parts are not shown in the figure). In the ROM for use by the CPU, an operation procedure of the control unit 101 fixed parameters, and other data are stored. In accordance with the operation of the control unit 101, information processed by the CPU is stored and read in/from the RAM for use by the CPU. A more detailed description will be given later as to a manner in which the control unit 101 controls the respective parts of the navigation apparatus 100, after the other parts of the navigation apparatus 100 are described. The operation of the navigation apparatus 100 as a whole will also be described when the control operation of the control unit 101 is described in further detail later.

The map data controller 106 and the control unit 101 are connected to each other via the bus line or via communication input/output ports of the map data controller 106 and the control unit 101. The map data controller 106 operates under the control of the control unit 101. More specifically, the control unit 101 determines how to combine data/information in various hierarchical levels stored in the DVD or data such as the map drawing data, the intersection data, the road data, the aerial photographic information, the satellite photographic information, and the area-specific information indicating hotel names, sightseeing information, and other useful information specific to each area, thereby to obtain data/information to be displayed on the image display unit 107. The control unit 101 controls the map data controller 106 to read necessary information from the map data disk drive 201 and to combine various data and/or photographic images thereby to produce data in a form properly displayable on the image display unit 107. Hereinafter, such data will be referred to simply as image display data.

Two memories, i.e., the ROM 104 and the RAM 105, are connected to the map data controller 106. In the ROM 104, a wide area map and a middle area map are stored in advance, for use regardless of the current running position of the vehicle. On the other hand, the RAM 105 works as a buffer for temporarily storing map information supplied from the map data controller 106 in the state in which the navigation apparatus 100 and the map data supply apparatus 200 are connected to each other, thereby allowing an image to be displayed at a high rate on the image display unit 107. On the other hand, in the mode in which the navigation apparatus 100 operates solely, the RAM 105 works as a memory for storing the detailed map information. The RAM 105 may be implemented using a volatile memory. Alternatively, the RAM 105 may be implemented using a nonvolatile memory, as long as it is possible to store the detailed map information. In the case where the RAM 105 is implemented using a nonvolatile memory, it becomes possible to retain information in the RAM 105 even after the power of the navigation apparatus 100 is turned off. This makes it possible to intermittently turn on the power of the navigation apparatus 100 thereby achieving a longer operation time of the navigation apparatus 100. For example, a flash memory (which is one of nonvolatile memories) with a storage capacity of, for example, 1 Gbyte may be used as the RAM 105. The small storage capacity of the RAM 105 can lead to a reduction in total cost of the apparatus. On the other hand, as for the ROM 104, a mini disc (MD), an IC card, a mask ROM, or other rewritable nonvolatile memory may be used. In the case where the ROM 104 is implemented using a nonvolatile rewritable memory, it is possible to realize both storage functions of the ROM 104 and the RAM 105 by using the single nonvolatile rewritable memory. That is, in this case, it is possible to store both wide/middle area map information and detailed map information in the single memory.

In the map data controller 106, a program indicating the procedure to be executed by the map data controller 106 is stored in advance. The procedure includes, for example, a procedure of processing various data and/or photographic information so as to produce data to be displayed in a visual manner on the image display unit 107.

The position measurement unit 103 is adapted to measure coordinates of the current position of the navigation apparatus 100, expressed in latitude and longitude, by mainly using a GPS (Global Positioning System) using satellites. The position measurement unit 103 includes at least a GPS receiver (not shown), and the position measurement unit 103 may further include a beacon receiver (not shown) for receiving position information from beacons disposed on roads, a direction sensor (not shown) a distance sensor (not shown), etc. The GPS receiver receives radio waves transmitted from satellites via an antenna, amplifies the received radio waves, and performs particular processes to determine the latitude and the longitude. The signal received via the antenna is input to the position measurement unit 103 via the antenna selection switch 113. The antenna selection switch 113 operates under the control of the control unit 101 such that if the eject button 204 is pressed and the control unit 101 controls the plunger so that the navigation apparatus 100 is brought into a state in which the navigation apparatus 100 is disconnectable from the map data supply apparatus 200, then the antenna selection switch 113 switches the connection so that the external antenna 300 is disconnected and the internal antenna 112 is connected.

As for the image display unit 107, a liquid crystal display, a plasma display, or other types of display device is used. A display screen of the image display unit 107 is disposed over a large area of a flat surface of the navigation apparatus 100 so that an image displayed thereon can be easily viewed by a user. The image display unit 107 is controlled by the control unit 101. The control unit 101 combines the image display data produced by the map data controller 106, the information indicating the current position measured by the position measurement unit 103, and additional information other than map information (hereinafter, referred to simply as associated additional information), and the control unit 101 displays the resultant information on the image display unit 107. The associated additional information may be read from the DVD or may be written in advance in the ROM 104. A description will be given later as to specific examples of contents of the associated additional information and as to how the associated additional information is used.

The operation input unit 108 is a part which provides an interface between a user and the navigation apparatus 100. In the mode in which the navigation apparatus 100 and the map data supply apparatus 200 are connected to each other, the operation input unit 108 functions as an interface between the user and the total system including the navigation apparatus 100 and the map data supply apparatus 200. The user is allowed to input a command via this operation input unit 108. The operation input unit 108 has touch switches. The touch switches may include a touch switch for turning on/off the power and other various touch switches for controlling the navigation functions provided by the combination of the navigation apparatus 100 and the map data supply apparatus 200. A specific example of a touch switch for controlling the navigation function is that for setting a destination. Instead of providing the touch switches, a voice recognition unit may be disposed in the operation input unit 108 so that the user is allowed to input voice commands.

A physical connection between the navigation apparatus 100 and the map data supply apparatus 200 is accomplished by a mechanical connection mechanism (not shown). In the mode in which the combination of the navigation apparatus 100 and the map data supply apparatus 200 operates as a car navigation system when the vehicle is running, the navigation apparatus 100 functions as a part of the car navigation system. In this case, the navigation apparatus 100 is fixed to the vehicle via a holding member such as a guide rail while maintaining the connection between the connector 302 and the connector 301. In the present embodiment, prohibition of disconnection between the connector 302 and the connector 301 and release of the prohibition are controlled using the plunger (not shown). The plunger is a part adapted to fix the navigation apparatus 100 to the vehicle by electromagnetic force. More specifically, for example, the position of a protruding hook is controlled. In a state in which no current is passed through the plunger, the hook is engaged in a recess formed on an outer surface of a case of the navigation apparatus 100 thereby locking the connection such that the navigation apparatus 100 cannot be disconnected from the vehicle. If a current is passed through the plunger, the lock is released and the navigation apparatus 100 is brought into a state in which it can be disconnected from the vehicle.

### Operation of Navigation Apparatus

In the present embodiment, when the vehicle is running, the navigation apparatus 100 provides usual navigation functions. In the mode in which the navigation apparatus 100 is separated from the map data supply apparatus 200, the navigation apparatus 100 operates in a unique manner according to the present embodiment. The navigation apparatus and the method of controlling the navigation apparatus according to the present embodiment are described below, in particular, as to how the navigation apparatus 100 operates.

Operation with Vehicle Running

When the vehicle is running or halting, the navigation apparatus 100 operates as a part of the navigation system 10. In this case, the navigation apparatus 100 is connected with the map data supply apparatus 200 adapted to supply map data via the connector 302 and the connector 301. In this state, electric power is supplied from the power supply 202 to the battery 109 via the power controller 110 to charge the battery 109. In this mode in which functions of car navigation are provided, it is possible to access information stored on the DVD mounted on the map data disk drive 201 to seamlessly obtain map information in any hierarchical level from map information of a wide area in the highest level to detailed map information in the lowest level.

The current position of the vehicle is determined as follows. Radio waves transmitted from satellites are received by the external antenna 300, and the latitude, the longitude, the time, and the altitude are calculated by the position measurement unit 103 from the received radio waves. On the basis of the vehicle position information (the information indicating the position of the navigation apparatus 100) determined by the position measurement unit 103, the control unit 101 controls the map data controller 106 to acquire detailed map information of an area surrounding the current position from the map data supply apparatus 200. The control unit 101 processes the acquired detailed map information and displays a map of the area surrounding the current position and a mark indicating the current position on the image display unit 107. The process described above is performed repeatedly at predetermined intervals of time such that the mark indicating the vehicle position is displayed on the map of the area surrounding the current position, and the map and the mark displayed on the image display unit 107 are updated as the vehicle moves. In this operation, as described above, the detailed map information necessary in displaying the map on the image display unit 107 is downloaded as required into the RAM 105 from the map data supply apparatus 200. This makes it possible to increase the processing speed associated with the image processing needed to display the map on the image display unit 107.

Operation Mode in which Navigation Apparatus is Carried by User

In a case where a driver stops the vehicle and the driver or a passenger, who is a user of the navigation apparatus 100, carries the navigation apparatus 100 with the user and goes to a destination on foot or by bicycle, the navigation apparatus 100 connected to the map data supply apparatus 200 and the power supply 202 via the connector 302 and the connector 301 is disconnected from the map data supply apparatus 200 and the power supply 202 and taken into the outside of the vehicle.

### First Embodiment

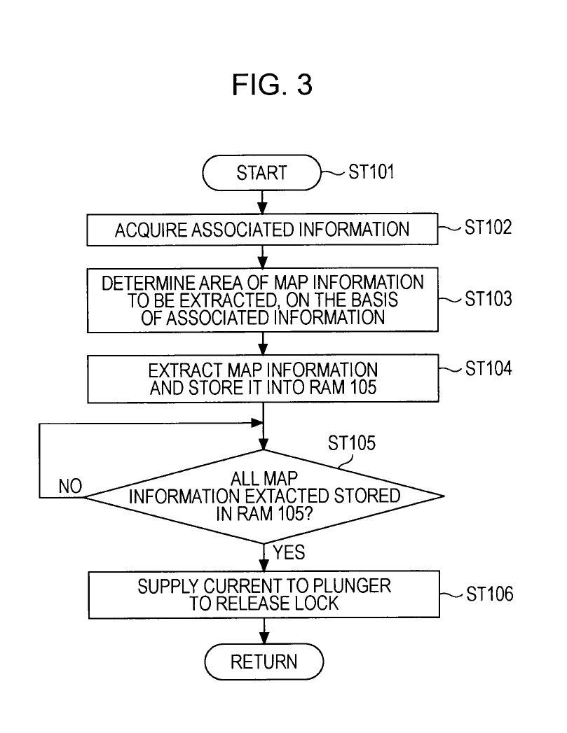

An operation of the navigation apparatus 100 according to a first embodiment of the invention is described below with reference to a flow chart shown in FIG. 3.

In the flow chart shown in FIG. 3, shown is a process of disconnecting the navigation apparatus 100 from the map data supply apparatus 200 including the map data disk drive 201 and the power supply 202. The disconnection process starts at step ST101. There can be many events that can cause the disconnection process to start. For example, in response to pressing of the eject button 204 of the operation input unit 108, the process may start. Alternatively, when the control unit 101 determines, from information supplied from the position measurement unit 103 or a vehicle control part, that the vehicle speed has been at 0 for a predetermined time, the disconnection process may start. Alternatively, when the control unit 101 detects, from information supplied from the vehicle data acquisition unit 206, that a parking brake has been operated, the disconnection process may start. Alternatively, when the vehicle is running, the process may start (step ST101) repeatedly at predetermined time intervals, and information stored in the RAM 105 may be updated repeatedly. Alternatively, when the control unit 101 detects that the vehicle speed has been at 0 for the predetermined time, only a particular process such as selecting candidates for information to be stored in the RAM 105 may be performed in accordance with movement of the vehicle position during the vehicle running operation, and the disconnection process may be started when the eject button 204 is pressed.

In step ST102, the control unit 101 reads associated additional information from a DVD mounted on the map data supply apparatus 200. As described above, the “associated additional information” is a generic expression of additional information useful for the user, such as information about landmarks located near the current position, train stations, train timetables, bus stops, bus timetables, estimated times needed for sightseeing of landmarks, times needed to get to landmarks estimated taking into account geographic conditions, etc.

In step ST103, on the basis of the associated additional information read in step ST102, the control unit 101 determines which area of the detailed map information should be extracted and read into the RAM 105.

In step ST104, in accordance with the result of the determination in step ST103, the control unit 101 controls the map data disk drive 201 to read necessary detailed map information from the DVD and stores the detailed map information in the RAM 105.

In step ST105, the control unit 101 determines whether all detailed map information has been stored in the RAM 105. If the determination is that all map information has not yet been stored in the RAM 105 (that is, the answer to step ST105 is No), the processing flow returns to step ST105 to store the remaining part of the detailed map information into the RAM 105.

On the other hand, in a case where the determination is that all map information has been stored in the RAM 105 (that is, the answer to step ST105 is Yes), the processing flow proceeds to step ST106.

In step ST106, a current is passed through the plunger thereby to release the lock between the navigation apparatus 100 and the map data supply apparatus 200 so as to make the navigation apparatus 100 come into the state in which the navigation apparatus 100 is allowed to be brought outside the vehicle. The lock may be released by the plunger when a further condition that the battery 109 has been charged sufficiently is satisfied in addition to the condition described above.

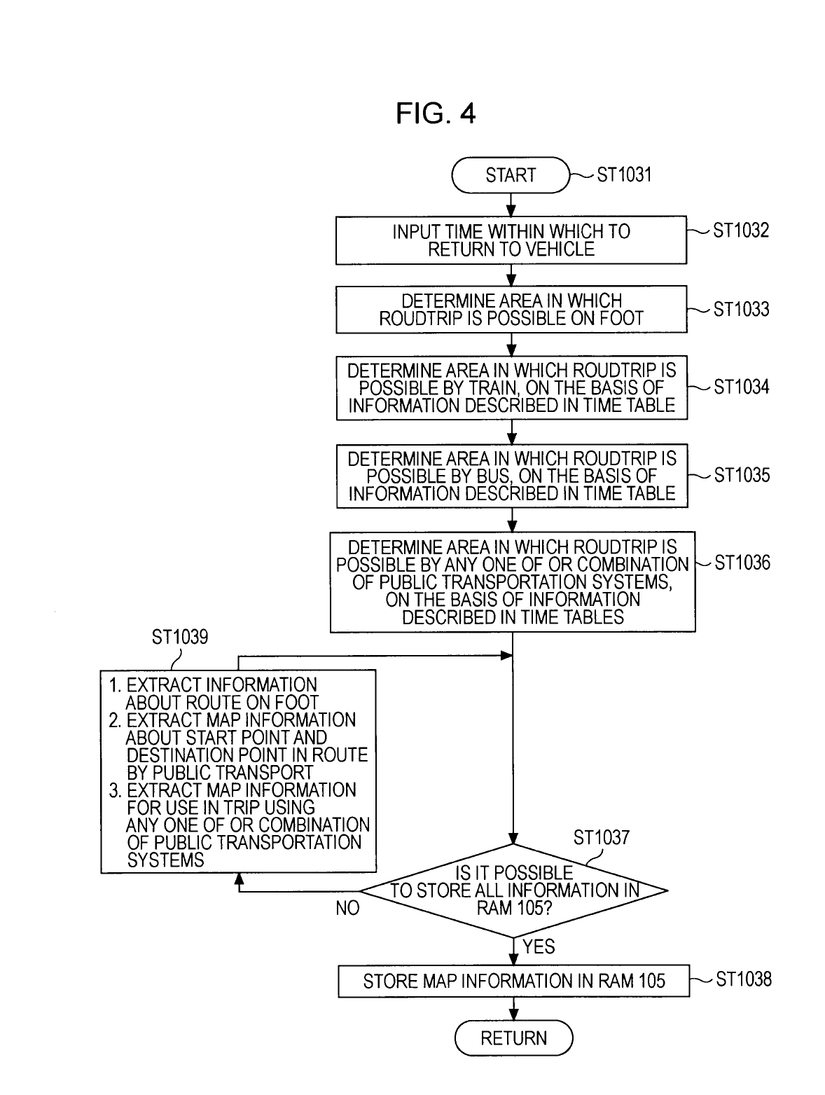

FIG. 4 is a flow chart illustrating the process (content-to-be-downloaded determination process) performed in step ST103 to determine which area of the detailed map information should be stored into the RAM 105. Referring to FIG. 4, the content-to-be-downloaded determination process is explained below.

The content-to-be-downloaded determination process starts in step ST1031.

In step ST1032, a user inputs a maximum allowable time during which the user wants to return back. The inputting is performed via the operation input unit 108. For example, “5:30” is input to specify the maximum allowable time.

In step ST1033, a determination is made as to an area to which a round trip from the parking lot on foot or by bicycle is possible within the maximum allowable time. This determination as to the area may be made taking into account additional factors such as a walking speed which may vary depending on geographical conditions, typical staying times at landmarks, the age of the user, i.e., whether the user is a child, an adult, or an old person, etc. The area is expressed on map data by a set of two-dimensional coordinates represented in latitude and longitude. In a case where the user gets to and from a destination not on foot but by a rental bicycle, the walking speed may be replaced by the bicycle running speed in the determination of the reachable area. In this case, a greater area is determined to be reachable.

In step ST1034, a determination is made as to an area to which a round trip by train is possible within the maximum allowable time. In this determination, a train which can be caught at an earliest time of all trains available for getting to a station closest to each landmark is determined on the basis of timetables described in the associated additional information taking into account the walking time to a station at which to get on the train and also taking into account the current time. Furthermore, a time at which the train will arrive at the station located closest to the landmark is determined. Thereafter, a total time needed to get to/from the landmark from/to the station and a typical stating time at the landmark are added to the arrival time at the station closest to the landmark. A train which can be caught at an earliest time after the time determined above is then detected among all trains available for getting back to the start station from the station closest to the landmark. Furthermore, a walking time from the start station to the vehicle is added to the train arrival time at the start station, and a determination is made as to whether the resultant total necessary time is less than the maximum allowable time (5 hours and 30 minutes). If the determination is that the total necessary time is less than the maximum allowable time, this area is determined to be a candidate for an area whose detailed map information is to be downloaded into the RAM 105. Note that this area includes two areas, i.e., an area including a route between the parking lot and the starting station and an area including the landmark, and thus these two areas are determined as candidates for areas whose detailed map information is to be downloaded into the RAM 105. Note that each area is expressed by a set of two-dimensional coordinates represented in latitude and longitude. Also note that the number of unique places such as landmarks is not limited to one, but any reasonable number of unique places may be selected by the control unit 101 on the basis of the associated additional information. In a case where a plurality of unique places are selected, each of a plurality of areas including the respective unique places accessible by trains is defined by a set of coordinates of points on a boundary of each area.

In step ST1035, a determination is made as to an area to which a round trip by bus is possible within the maximum allowable time. Also in this case, the determined area is expressed by a set of coordinates. In step ST1036, on the basis of timetables, a determination is made as to an area to which a round trip using any one of or any combination of public transportation systems including trains, buses, etc., is possible within the maximum allowable time. The process in step ST1036 is a combination of processes in steps ST1034 and ST1035. That is, an area to which a round trip using trains and buses within the maximum allowable time is determined on the basis of timetables. Also in this case, the determined area is expressed by a set of coordinates.

In step ST1037, a determination is made as to whether the data size of the map information of all areas given by the sets of coordinates determined via the processes in steps ST1034 to ST1036 is equal to or smaller than a maximum allowable data size which can be stored in the RAM 105. If the determination is that the data size of the map information is within the maximum allowable data size which can be stored in the RAM 105 (that is, if the answer to step ST1037 is Yes), the detailed map information of the areas given by the sets of coordinates determined via the processes in steps ST1034 to ST1036 is all stored in the RAM 105 (step ST1038). On the other hand, in a case where the determination is that the data size of the map information is not within the maximum allowable data size (that is, if the answer to step ST1037 is No), the processing flow proceeds to step ST1039.

In step ST1039, the data size of the detailed map information to be stored in the RAM 105 is reduced. The reduction in the total data size of the detailed map information of the areas determined via steps ST1034 to ST1036 and expressed by sets of coordinates may be accomplished in various manners. For example, the total data size can be reduced according to a procedure described below.

(1) The data size of the detailed map information associated with the walking route (including the bicycle route) is calculated, and it is determined whether the whole detailed map information associated with the walking route can be stored in the RAM 105. If the result of the determination is affirmative, it is determined that the detailed map information associated with the walking route is to be stored in the RAM 105 (that is, walking route information is extracted). Subsequently, the remaining available storage capacity of the RAM 105 is determined by subtracting the data size of the waling rout information from the total storage capacity of the RAM 105.

On the other hand, in a case where it is determined that the storage capacity of the RAM105 is not enough to store the detailed map information associated with the walking route, it is determined that the detailed map information associated with the walking route is not to be stored in the RAM 105. This results in a reduction in the data of the detailed map information stored in the RAM 105.

(2) Next, the total data size of detailed map information associated with a train/bus start area (including the parking lot and the train/bus start point) and detailed map information associated with a destination area (including the getting-off station and the landmark) is calculated, and a determination is made as to whether the remaining available storage capacity of the RAM 105 is enough to store the detailed map information. If it is determined that it is possible to store the detailed map information associated with one or both of the train and the bus in the RAM 105, then it is determined that this detailed map information is to be stored in the RAM 105 (i.e., map information associated with the start point and the arrival point of the public transportation system is extracted). The data size of the detailed map information associated with the start point and the arrival point of the public transportation system is subtracted from the current remaining storage capacity of the RAM 105 thereby to determine the resultant remaining storage capacity of the RAM 105.

On the other hand, in a case where it is determined that the current remaining storage capacity of the RAM 105 is not enough to store the detailed map information associated with one or both of the train and the bus, then it is determined that this detailed map information associated with one or both of the train and the bus is not to be stored in the RAM 105. This results in a reduction in the data size of the detailed map information stored in the RAM 105.

(3) Next, the data size of the detailed map information associated with the start point and the arrival point is calculated for the case where any allowable combination of public transportation systems including trains and buses is used, and a determination is made as to whether the current remaining storage capacity of the RAM 105 is enough to store the detailed map information. If the determination is affirmative, then it is determined that the detailed map information associated with the start point and the arrival point using the combination of public transportation systems is to be stored in the RAM 105 (i.e., map information associated with the combination of public transportation systems is extracted).

On the other hand, in a case where it is determined that the current remaining storage capacity of the RAM 105 is not enough to store the detailed map information associated with the combination of public transportation systems, it is determined that the detailed map information associated with the combination of public transportation systems is not to be stored in the RAM 105. This results in a reduction in the data size of the detailed map information stored in the RAM 105.

Note that processes (1) to (3) of the data size reduction procedure in step ST1039 have been described above only by way of example, and the data size reduction may be accomplished in many ways. For example, exchange is possible among processes (1) to (3). After processes (1) to (3) in step ST1039 are completed, the processing flow returns to step ST1037. In this case, because the data size of the detailed map information has been reduced in step ST1039 so that the resultant detailed map information can be stored in the RAM 105, the answer to step ST1037 is affirmative, and thus the processing flow proceeds to step ST1038.

Alternatively, in step ST1039, when the storage capacity of the RAM105 is not enough to store all map information, instead of discarding one or more of the detailed map information associated with the route on foot or by bicycle, the detailed map information associated with the start point and the arrival point of one of public transportation system, and the detailed map information associated with the start point and the arrival point using the combination of public transportation systems, the precision of map information may be reduced to achieve a reduction in the data size, and resultant map information of all three kinds described above may be stored in RAM 105.

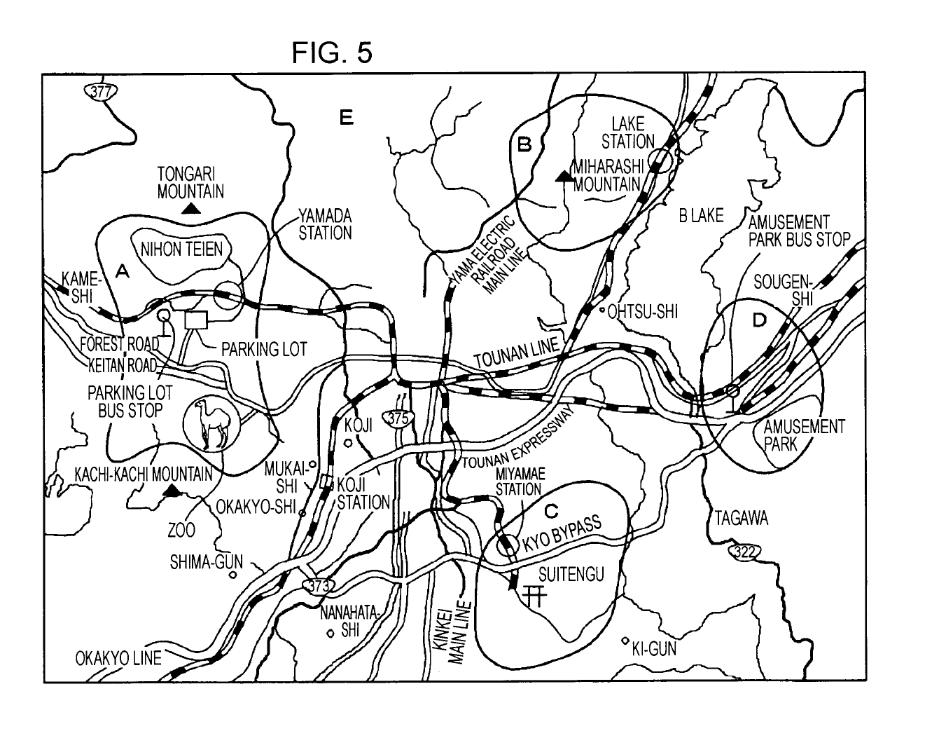

FIG. 5 illustrates map information of a wide/middle area stored in the ROM 104 and also illustrates areas whose detailed map information is stored in the RAM 105 according to the first embodiment. In FIG. 5, an area E is a wide/middle area displayed in accordance with map information stored in the ROM 104. In FIG. 5, areas A to D (areas surrounded by respective solid curves indicating boundaries of the areas and denoted by marks A to D in FIG. 5) are areas whose detailed map information is downloaded into the RAM 105. In the case where the ROM 104 is realized using a nonvolatile memory, when the map information is updated after a new road or the like is constructed, it is possible to replace the map information in the ROM 104 by the updated map information as required.

The area A is an area to which a round trip from the parking lot by bicycle is possible within 5 hours and 30 minutes. The area A is not circular in shape because there are many slopes near Mt. TONGARI and Mt. KACHI-KACHI. The area A includes NIHON TEIEN, a zoo, a bus stop “PARKING LOT”, and a train station “YAMADA”. The control unit 101 automatically extracts the area A taking into account the fact that a typical time spent to walk around NIHON TEIEN after getting off a bicycle is 1 hour, and the fact that a typical time spent for a trip around the zoo is 1 hour and 30 minutes. Note that the term “extract” is used in the present embodiment to describe the process of downloading a particular part of the map information stored in the map data supply apparatus 200 into the RAM 105.

The area B is an area including a landmark Mt. MIHARASHI to which a round trip using a train from YAMADA station is possible within 5 hours and 30 minutes. That is, the area B including Mt. MIHARASHI is selected by the control unit 101 as an area to which a round trip is possible within the maximum allowable time, as a result of overall judgment on a total train travel time between YAMADA station and LAKE station, a train time schedule described in a timetable, and a typical time spent on Mt. MIHARASHI. A specific example of a process of determining whether the area B is a candidate for an area whose detailed map information is to be stored into the RAM 105 is explained below, for a specific case where the vehicle is parked at the parking lot at 10:30. In this case, the control unit 101 determines that a round trip along a route described below is possible within 5 hours and 30 minutes, on the basis of estimation in terms of time passage, as follows.

In this case, the associated additional information includes a time (30 minutes) needed to get to YAMADA station on foot from the parking lot, a timetable indicating a time schedule from YAMADA station to Lake station (see TABLE 1), a typical trip time (2 hours) needed to get to Mt. MIHARASHI from Lake station, take a trip around Mt. MIHARASHI, and return to Lake station, and a timetable indicating a train schedule from LAKE station to YAMADA station (see Table 2).

TABLE 1
TRAIN TIMETABLE

| YAMADA STATION | LAKE STATION |
|---|---|
| (DEPARTURE TIME) | (ARRIVAL TIME) |
| 7:30 | 8:30 |
| 11:15 | 12:15 |
| 12:30 | 13:30 |
| 13:30 | 14:35 |
| 16:30 | 17:38 |
| 17:30 | 18:38 |
| 18:30 | 19:38 |
| 20:30 | 21:30 |

TABLE 2
TRAIN TIMETABLE

| LAKE STATION | YAMADA STATION |
|---|---|
| (DEPARTURE TIME) | (ARRIVAL TIME) |
| 7:30 | 8:40 |
| 10:15 | 11:15 |
| 12:30 | 13:30 |
| 14:28 | 15:27 |
| 16:30 | 17:32 |
| 17:30 | 18:32 |
| 18:40 | 19:32 |
| 20:38 | 21:39 |

On the basis of the associated additional information described above, the control unit 101 makes determinations as follows. It will take 30 minutes to walk to YAMADA station from the parking lot, and thus the user will arrive at YAMADA station at 11:00. At YAMADA station, the user will get on a train, which is scheduled to depart from YAMADA station at 11:15. The train will arrive at LAKE station at 12:15. After the user arrives at LAKE station, the user will take a trip around Mt. MIHARASHI and will return back to LAKE station at 14:15. At LAKE station, the user will get on a train scheduled to depart at 14:28, and the train will arrive at YAMADA station at 15:27. The user will walk from YAMADA station to the parking lot. This will take 30 minutes, and thus the user will arrive at the parking lot at 15:57. Thus, the control unit 101 determines that this round trip starts from the parking lot at 10:30 and ends when the user returns back to the parking lot at 15:57, and thus this round trip takes 5 hours and 27 minutes in total. Thus, the control unit 101 determines that the map information of the area B, which is one of sightseeing areas, is a candidate for detailed map information to be stored into the RAM 105.

The area C is an area including a landmark “SUITENGU” to which a round trip using a train from YAMADA station is possible within 5 hours and 30 minutes. That is, the area C including SUITENGU is selected by the control unit 101 as an area to which a round trip is possible within the maximum allowable time, as a result of overall judgment on a total train travel time between YAMADA station and MIYAMAE station, a train time schedule described in a timetable, and a typical time spent to have a trip around SUITENGU. A specific example of a process of determining whether the area C is a candidate for an area whose detailed map information should be stored into the RAM 105 is explained in detail below, for a specific case where the vehicle is parked at the parking lot at 10:30.

In this case, the associated additional information includes a time (30 minutes) needed to get to YAMADA station on foot from the parking lot, a timetable indicating a train schedule from YAMADA station to MIYAMAE station (see TABLE 3), a typical trip time (1 hour and 30 minutes) needed to get to SUITENGU from MIYAMAE station, take a trip around SUITENGU, and return to MIYAMAE station, and a timetable indicating a train schedule from MIYAMAE station to YAMADA station (see TABLE 4).

TABLE 3
TRAIN TIMETABLE

| YAMADA STATION | MIYAMAE STATION |
|---|---|
| (DEPARTURE TIME) | (ARRIVAL TIME) |
| 7:10 | 7:55 |
| 11:20 | 12:05 |
| 13:10 | 14:55 |
| 14:10 | 14:55 |
| 18:10 | 18:58 |
| 19:10 | 19:58 |
| 20:10 | 20:58 |

TABLE 4
TRAIN TIMETABLE

| MIYAMAE STATION | YAMADA STATION |
|---|---|
| (DEPARTURE TIME) | (ARRIVAL TIME) |
| 7:50 | 8:35 |
| 10:15 | 11:00 |
| 12:15 | 13:01 |
| 14:00 | 15:45 |
| 16:00 | 17:46 |
| 17:00 | 18:45 |
| 18:00 | 19:45 |
| 19:00 | 20:45 |
| 20:00 | 21:45 |

In this case, the control unit 101 determines that a round trip along a route described below is possible within 5 hours and 30 minutes, on the basis of estimation in terms of time passage, as follows. It will take 30 minutes to walk to YAMADA station from the parking lot, and thus the user will arrive at YAMADA station at 11:00. At YAMADA station, the user will get on a train, which is scheduled to depart from YAMADA station at 11:20. The train will arrive at MIYAMAE station at 12:05. After the user arrives at MIYAMAE station, the user will take a trip around SUITENGU and will return back to MIYAMAE station at 13:35. At MIYAMAE station, the user will take a train scheduled to depart at 14:00, and the train will arrive at YAMADA station at 14:45. The user will walk from YAMADA station to the parking lot. This will take 30 minutes, and thus the user will arrive at the parking lot at 15:15. That is, the control unit 101 determines that this round trip starts from the parking lot at 10:30 and ends when the user returns back to the parking lot at 15:15, and thus this round trip takes 4 hours and 45 minutes in total. Thus, the control unit 101 determines that the map information of the area C, which is one of sightseeing areas, is a candidate for detailed map information to be stored into the RAM 105.

The area D is an area including an amusement park which is one of landmarks and to which a round trip by bus from PARKING LOT bus stop is possible within 5 hours and 30 minutes. That is, the area D including the amusement park is selected by the control unit 101 as an area to which a round trip is possible within the maximum allowable time, as a result of overall judgment on a total travel time by bus between PARKING LOT bus stop and AMUSEMENT PARK bus stop, a bus time schedule described in a timetable, and a typical time spent in the amusement park. For this area, the control unit 101 determines that a round trip along a route described below is possible within 5 hours and 30 minutes, on the basis of estimation in terms of time passage, as follows.

In this case, the associated additional information includes a time (5 minutes) needed to get to PARKING LOT bus stop on foot from the parking lot, a timetable indicating a bus schedule from PARKING LOT bus stop to AMUSEMENT PARK bus stop (see TABLE 5), a typical trip time (1 hour and 30 minutes) needed to get to AMUSEMENT PARK bus stop from PARKING LOT bus stop, enjoy in the amusement park, and return to AMUSEMENT PARK bus stop, and a timetable indicating a bus schedule from AMUSEMENT PARK bus stop to PARKING LOT bus stop (see TABLE 6).

TABLE 5
TRAIN TIMETABLE

| MIYAMAE STATION | YAMADA STATION |
|---|---|
| (DEPARTURE TIME) | (ARRIVAL TIME) |
| 7:50 | 8:35 |
| 10:15 | 11:00 |
| 12:15 | 13:01 |
| 14:00 | 15:45 |
| 16:00 | 17:46 |
| 17:00 | 18:45 |
| 18:00 | 19:45 |
| 19:00 | 20:45 |
| 20:00 | 21:45 |

TABLE 6
BUS TIMETABLE

| AMUSEMENT PARK | PARKING LOT |
|---|---|
| (DEPARTURE TIME) | (ARRIVAL TIME) |
| 7:50 | 8:35 |
| 10:15 | 11:00 |
| 12:15 | 13:01 |
| 14:00 | 15:45 |
| 16:00 | 17:46 |
| 17:00 | 18:45 |

It will take 5 minutes to walk to PARKING LOT bus stop on foot from the parking lot, and thus the user will arrive at PARKING LOT bus stop at 10:05. At PARKING LOT bus stop, the user will get on a bus scheduled to depart at 10:23. The bus will arrive at AMUSEMENT PARK bus stop at 11:55. It will take 2 hours to get to the amusement park, enjoy in the amusement park, and return to AMUSEMENT PARK bus stop, and thus the user will return back to AMUSEMENT PARK bus stop at 13:55. At AMUSEMENT PARK bus stop, the user will get on a bus scheduled to depart therefrom at 14:00. The bus will arrive at PARKING LOT bus stop at 15:37. It will take 5 minutes to walk from PARKING LOT bus stop to the parking lot, and thus the user will arrive at the parking lot at 15:42. That is, the control unit 101 determines that this round trip starts from the parking lot at 10:30 and ends when the user returns back to the parking lot at 15:42, and thus this round trip takes 5 hours and 12 minutes in total. Thus, the control unit 101 determines that the map information of the area D, which is one of sightseeing areas, is a candidate for detailed map information to be stored into the RAM 105.

In the first embodiment, as described above, when the extracted detailed map information is stored in the RAM 105, not only detailed map information of an area to which a round trip on foot or by bicycle is possible (hereinafter, referred to as extracted detailed map information to be stored in the RAM 105) is stored in the RAM 105, but additional detailed map information of a route to a sightseeing spot and detailed map information of a sightseeing spot and a nearby area are also stored. This makes it possible to handle a case in which after a user gets to a sightseeing spot by an automobile, the user takes a trip around the sightseeing spot on foot or using a rental bicycle or other similar moving tool. This makes it possible to effectively expand an area for which a detailed map is provided to a person who walks or uses a rental bicycle or the like, without increasing the data size of map information. That is, the area A is not simply determined such that the edge thereof is defined at a constant physical distance with reference to a particular point, but the area A is determined such that the area A includes the parking lot, NIHON TEIEN and the zoo as sightseeing spots, PARKING LOT bus stop and YAMADA station which allow a user to use public transportation systems, and detailed map information associated with this area is downloaded in the RAM 105.

As described above, the detailed map information of the areas A to D are stored in the RAM 105 via steps ST1034 to ST1036. However, detailed map information of a KOJI area, which is physically closer to the current position than the areas B and C, is not stored in the RAM 105 for the following reason.

That is, the detailed map information of the KOJI area is not stored in the RAM 105, because the control unit 101 determines that a round trip to the KOJI area along a route described below is not possible within 5 hours and 30 minutes, on the basis of estimation in terms of time passage, as described below.

In this case, the associated additional information includes a time (30 minutes) needed to get to YAMADA station on foot from the parking lot, a timetable indicating a train schedule from YAMADA station to KOJI station (see TABLE 7 (note that trains of TOZAI line and/or OKAKYO line are available from YAMADA station to KOJI station)), a typical time (1 hours and 20 minutes) needed to take a round trip from KOJI station to KOJI including a time (20 minutes) needed to walk to KOJI from KOJI station, a typical time (40 minutes) spent at KOJI, and a time (20 minutes) needed to walk from KOJI to KOJI station, and a timetable indicating a train schedule from KOJI station to YAMADA station (see TABLE 8 (note that trains of TOZAI line and/or OKAKYO line are available from KOJI station to YAMADA station)).

TABLE 7
TRAIN TIMETABLE

| YAMADA STATION | KOJI STATION |
|---|---|
| (DEPARTURE TIME) | (ARRIVAL TIME) |
| 7:20 | 7:50 |
| 7:40 | 8:10 |
| 8:40 | 9:10 |
| 9:40 | 10:10 |
| 13:40 | 14:10 |
| 16:40 | 17:10 |
| 17:40 | 18:00 |
| 18:40 | 19:10 |
| 19:40 | 20:10 |
| 20:40 | 21:10 |

TABLE 8
TRAIN TIMETABLE

| KOJI STATION | YAMADA STATION |
|---|---|
| (DEPARTURE TIME) | (ARRIVAL TIME) |
| 6:45 | 7:50 |
| 7:05 | 7:50 |
| 7:35 | 8:10 |
| 8:30 | 9:10 |
| 9:30 | 10:10 |
| 10:30 | 11:10 |
| 13:30 | 14:10 |
| 15:30 | 16:10 |
| 17:30 | 18:10 |
| 18:30 | 19:10 |

In this case, the control unit 101 determines that there is no way to take the round trip within 5 hours and 30 minutes, on the basis of estimation in terms of time passage, as follows. The current time is 10:30, and it will take 30 minutes to walk to YAMADA station from the parking lot. Thus the user will arrive at YAMADA station at 11:00. At YAMADA station, the user will get on a train scheduled to depart from YAMADA station at 13:40. The train will arrive at KOJI station at 14:10. After the user arrives at KOJI station, the user will take a trip around KOJI and will return back to KOJI station at 15:30. At KOJI station, the user will get on a train scheduled to depart at 15:30. The train will arrive at YAMADA station at 16:10. The user will walk from YAMADA station to the parking lot. This will take 30 minutes, and thus the user will arrive at the parking lot at 16:40. That is, the control unit 101 determines that this round trip starts from the parking lot at 10:30 and ends when the user returns back to the parking lot at 16:40, and thus this round trip takes 6 hours and 10 minutes in total. Thus, the control unit 101 determines that the detailed map information of the KOJI area, which is one of sightseeing spots, is not selected as a candidate for detailed map information to be stored in the RAM 105, because this round trip will ends at a time much later than 16:00 at which it is planned to leave for a next destination. By selecting areas whose detailed map information is downloaded into the RAM 105 in the above-described manner, it is possible to greatly reduce the data size of the detailed map information stored in the RAM 105.

In the example described above, the maximum time allowable for round trips is set to 5 hours and 30 minutes. The maximum allowable time may be determined in various other manners. In a first alternative, a planned arrival time by which the user wants to arrive at a final destination point is determined in advance before a trip is started. An estimated average travel time from a parking lot to the final destination point is subtracted from the planned arrival time, and a resultant time is regarded as an estimated return time at the parking lot. The difference between the current time and the return time is regarded as a time allowed to be spent at the current position. The planned arrival time at the final destination point may be given by a time input to a personal computer (PC) used to make a reservation of a hotel at the final destination point.

In another alternative, a closing time of the parking lot is acquired from the associated additional information attached to the map information, and the difference between the closing time and the current time is regarded as the maximum time allowable for the round trip. In this case, the maximum time allowable for the round trip is automatically determined without having to input any data. In this case, when the navigation apparatus is set to operate in the mode in which the information stored in the RAM 105 is automatically updated as the vehicle current position changes or in the mode in which when the control unit 101 detects that the vehicle running speed has been at 0 for a predetermined time, only the particular process is performed according to the current vehicle position, and the information stored in the RAM 105 is updated when the eject button 204 is pressed, the maximum time allowable for the round trip is automatically determined without having to manually input any data, and thus a drastic improvement in convenience can be achieved.

In the first embodiment described above, the process is properly performed not only for a case where movement is performed on foot or by bicycle but also for a case where public transportation systems such as a train or a bus available in sightseeing areas are used. In this case, on the basis of timetables indicating running schedules of available public transportation systems and taking into account the current time, searching may be performed to find sightseeing spots to which a round trip starting from the current position is possible within a maximum allowable time including a time spent at a sightseeing spot, and only detailed map information necessary in providing navigation guidance along routes to sightseeing spots and detailed map information of sightseeing areas may be downloaded. This provides further improved convenience. In the first embodiment, when the user is on a train, there is no possibility that the user gets lost, and thus detailed map information associated with a railroad line is not downloaded in the RAM 105.

A maximum operable time may be determined from a remaining battery capacity, and the maximum operable time may be included in criteria according to which to select areas for which detailed map information is downloaded in the RAM 105. This leads to a further reduction in the data size of detailed map information stored in the RAM 105. Because the detailed map information stored in the RAM 105 is managed in the proper manner as described above, it is possible to store detailed map information of a greater area using a small-capacity storage device than can be by other techniques.

### Second Embodiment

In a case where, for example, a large natural park or the like is specified as a destination in a usual car navigation system, a route guidance is provided, in general, only to a point accessible by a car in a peripheral area of the natural park. Such a car navigation system designed to provide route guidance only for vehicle roads does not provide any route guidance about narrow pedestrian alleys or the like which are not accessible by vehicles, and thus there is a possibility that the user has a difficulty in getting to a final destination point. In particular, there is a possibility that the user has a very serious problem if the user gets lost in a mountain area. The portable navigation apparatus according to an embodiment of the invention can provide very high convenience to the user when the user walks in such an area. The navigation technique according to the second embodiment is very useful in particular in use in the situation described above. More specifically, detailed map information is downloaded in the RAM 105 for a walking route from a parking lot to a final destination point and also a route of a public transportation system if necessary, and route guidance is provided on the basis of the detailed map information for the route taken after the user gets off the vehicle, continuously following vehicle route guidance before the use gets off the vehicle.

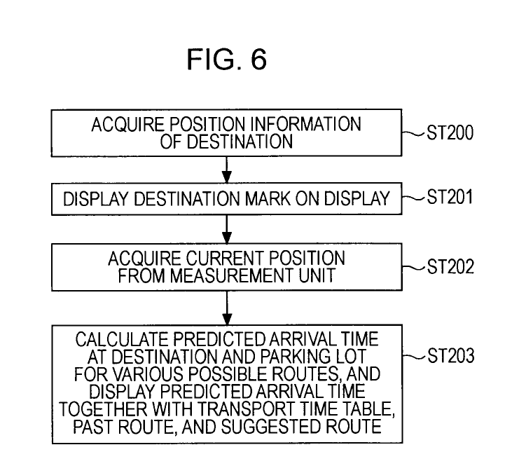

In this case, the detailed map information stored in the RAM 105 is selected so as to include detailed map information of the whole natural park, and associated additional information indicating route information and time schedule information of a transportation system usable to access to the natural park is also stored in the RAM 105. This makes it possible for the user to get to a second destination point (which may be an original start point) using the transportation system after the user passes through the natural park and arrives at a station/stop of the transportation system. FIG. 6 is a flow chart illustrating a specific example of a process performed by the control unit 101 of the navigation apparatus 100 according to the second embodiment. Note that the detailed map information stored in the ROM 104 is selected so as to include not only detailed map information of the whole natural park but also detailed map information of adjacent areas so that it is possible to handle a case where the user gets lost and walks along a path other than the planned route.

The navigation apparatus 100 is disconnected from the map data supply apparatus 200 in a similar manner as described above with reference to the flow chart shown in FIG. 3, and thus a duplicated explanation is not given herein. The detailed map information and the associated information as to the natural park, routes of transportation systems, time schedules may be selected and stored in the RAM 105 in a similar manner as described above with reference to FIG. 5, except that the detailed map information stored in the RAM 105 is expanded so as to include detailed map information of a greater spatial area and associated information of expanded items, for use in emergency which can occur when the user gets lost.

Spatially, the detailed map information of the whole natural park and detailed map information of an area reachable, for example, by a two-day walk are downloaded.

The associated information is selected so as to include timetables of all transportation systems available in the area reachable by the two-day walk.

Now, with reference to the flow chart shown in FIG. 6, the process performed by the control unit 101 of the navigation apparatus 100 according to the second embodiment is explained below.

The control unit 101 accepts position information indicating a destination point input via the operation input unit 108 (step ST200).

The control unit 101 displays a mark indicating the specified destination point on a map image displayed on the image display unit 107 (step ST201).

The control unit 101 acquires the current position of the user determined by the position measurement unit 103, wherein the current position changes with time (step ST202).

The control unit 101 repeatedly calculates the estimated arrival time at the destination point and the estimated return time at the parking lot at which the vehicle is parked, and the control unit 101 displays, on the image display unit 107, calculated arrival time and return time together with the past route and a suggested route along which the user will proceed, and a timetable of a transportation system (step ST203).

In step ST203 described above, the estimated arrival time at the destination point and the estimated return time at the parking lot may be displayed for each of a plurality of possible routes.

For example, for a possible route in which after the user arrives at the destination point, the user returns back to the parking lot on foot, information indicating the route, the estimated arrival time at the destination point, the estimated return time at the parking lot, and estimated times at which characteristic points will be passed through, is displayed on the image display unit 107.

For example, for a possible route in which after the user walks to the destination point, the user further walks to a bus stop, and then returns back to the parking lot by bus, information indicating the route, the estimated arrival time at the destination point, the estimated arrival time at the bus stop, and the estimated return time at the parking lot is displayed on the image display unit 107.

For a possible route in which after the user arrives at the destination point, the user further walks to a train station and returns back to the parking lot by a train, information indicating the route, the estimated arrival time at the destination point, the estimated arrival time at the station, and the estimated return time at the parking lot is displayed on the image display unit 107.

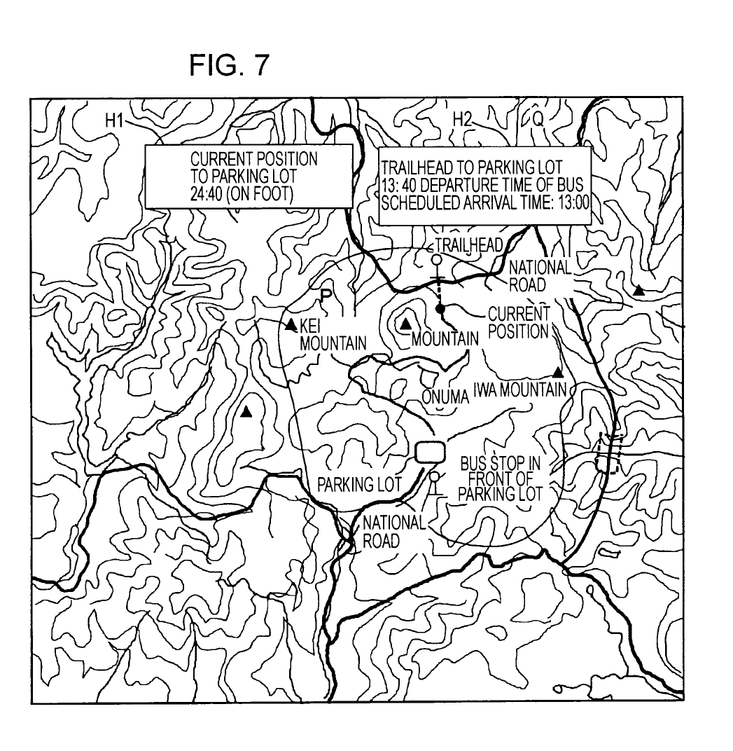

FIG. 7 illustrates an example of map information of a wide/middle area stored in the ROM 104, and detailed map information of an area downloaded in the RAM 105, according to the second embodiment. In the ROM 105, the map information of the wide/middle area Q including the whole area of the natural park (over a whole rectangular area of FIG. 7) is stored. Detailed map information is downloaded in the RAM 105 for an area P (surrounded by a solid line in FIG. 7). In FIG. 7, in addition to the areas whose map information is stored in the ROM 104 or the RAM 105, an image of the wide/middle-area map displayed on the image display unit 107 in accordance with map information stored in the ROM 105 is also shown. Note that the image is formed in accordance with image data produced based on an aerial picture clearing showing geographical shapes of mountains and valleys, and narrow walkable paths are added to the aerial picture.

The area P is an area in which hiking is planned. The area P includes a parking lot at which a vehicle is parked, a hiking route, unique points including ONUMA, IWA-YAMA, MOUNTAIN, and KEI-MOUNTAIN, a bus stop located in front of the parking lot, and a bus stop located at a trailhead. The image information displayed on the image display unit 107 may include information such as information Hi and information H2 as in the example shown in FIG. 7 in addition to or instead of the map information in a partial area or in a whole area of the display screen. In the example shown in FIG. 7, the information Hi and the information H2 are displayed in a manner in which they are superimposed on the map information. The information H1 represents an estimated return time at the parking lot calculated for a case in which the user walks from the current position to the parking lot. The information H2 indicates that a bus for the parking lot will depart from the trailhead at 13:40, and also indicates that the user will arrive at the bus stop at the trailhead at 13:00 if the user walks at the current pace. In a case where it is predicted that the user will probably not arrive at the bus stop at the trailhead by 13:40, the control unit 101 searches the timetable described in the associated additional information to find a departure time of a bus available after 13:40, and displays the departure time found in the search as the information H2. According to the displayed information H1 and the information H2, the user may plan to get on the bus scheduled to depart from the trailhead at 13:40 to return back to the parking lot.

That is, in the second embodiment, on the basis of information indicating the user's current position changing with time, the control unit 101 of the navigation apparatus 100 repeatedly calculates the estimated return time at which the user will finally arrive at the parking lot, and the control unit 101 compares the estimated return time with departure times of transportation systems. If the comparison indicates that a transportation system is usable, the navigation apparatus 100 informs the user of this fact. The user may use the transportation system to return back to the parking lot according to a suggestion provided by the navigation apparatus 100. By storing the map information of the adjacent area in addition to the map information of the whole natural park in the ROM 104, it becomes possible for the user to recognize the current position of the user even in a case where the user has gotten lost and has gone to a point greatly deviated from the planned route. In the case where the ROM 104 is implemented using a nonvolatile memory, it is allowed to temporarily turn off the power of the navigation apparatus 100 to minimize the consumption of the battery 109 thereby to achieve an increase in the operation time of the navigation apparatus 100.

In the first embodiment and also in the second embodiment described above, it is assumed that the user will return to the start point after the user arrives at the destination point. Note that route guidance may be provided for various routes. For example, after a first destination point is reached, route guidance may be provided for a route to a second destination point different from the start point and for a route to the start point after the second destination point is reached.

It should be understood by those skilled in the art that various modifications, combinations, sub-combinations and alterations may occur depending on design requirements and other factors insofar as they are within the scope of the appended claims or the equivalents thereof.

What is claimed is:

1. A navigation apparatus adapted to provide route guidance to a destination point, comprising:
a position measurement unit adapted to measure a position;
a storage unit adapted to store map information;
an image display unit adapted to display the map information in the form of a visual image;
a map data controller adapted to read the map information from a map data supply apparatus disposed outside the navigation apparatus and store the map information in the storage unit; and
a control unit adapted to control the position measurement unit, the storage unit, and the map data controller,
the control unit being adapted to control the position measurement unit to obtain a current position, detect one or more unique places reachable from the current position on the basis of information supplied from the map data supply apparatus in terms of a transport system and in terms of the unique places, determine map information of an area for use in providing route guidance to the unique places from the current position, and control the map data controller to read the determined map information of the area from the map data supply apparatus and store the map information in the storage unit.

2. The navigation apparatus according to claim 1, wherein
the unique places include a landmark, and the information associated with the unique places includes information indicating a location of the landmark and information indicating a typical trip time needed to make a trip around the landmark,
the information associated with the transportation system includes route information of the transport system to the landmark and time information of the transport system, and
the map information of the area includes map information of an area including the current position and a departure point of the transportation system, and map information of an area including the landmark and an arrival point of the transportation system.

3. The navigation apparatus according to claim 1, wherein
the unique places include a getting-on/off point which is located close to a first destination point and at which the transportation system is available,
the information associated with the transportation system includes route information from the getting-on/off point of the transportation system and time information of the transportation system, and
the control unit displays, on the image display unit, a route reaching a second destination point via the first destination point and a predicted time at which the first destination point or the second destination point will be reached, on the basis of the route information, the time information, and the current position measured by the position measurement unit.

4. A method of controlling a navigation apparatus adapted to read map information from a map data supply apparatus disposed outside the navigation apparatus, store the map information in a storage unit disposed in the navigation apparatus, and provide route guidance associated with a route to a destination point in accordance with the map information, comprising the steps of:
measuring a current position;
detecting one or more unique places reachable from the current position, on the basis of information associated with a transportation system; and
reading map information of an area for use in providing route guidance from the current position to the one or more unique places from the map data supply apparatus and storing the map information in the storage unit.
